(19) United States
(12) Patent Application Publication
(10) Pub. No.: US 2011/0091987 A1
(43) Pub. Date: Apr. 21, 2011

(54) Miniaturized Magnetic Resonance Systems and Methods

(76) Inventors: Ralph Weissleder, Peabody, MA (US); Hakho Lee, Cambridge, MA (US); Donhee Ham, Cambridge, MA (US); Nan Sun, Cambridge, MA (US); Yong Liu, New York, NY (US)

(21) Appl. No.: 12/681,303

(22) PCT Filed: Oct. 6, 2008
(86) PCT No.: PCT/US08/11541

§ 371 Date: Dec. 9, 2010

Related U.S. Application Data
(60) Provisional application No. 60/977,580, filed on Oct. 4, 2007.
(60) Provisional application No. 61/047,659, filed on Apr. 24, 2008.

(51) Int. Cl. G01N 24/08; B01J 19/00

(52) U.S. Cl. 436/173; 422/69

(57) ABSTRACT

The present application describes devices, systems, and techniques related to a chip-based, miniaturized NMR diagnostic platform for rapid, quantitative and multi-channeled detection of biological targets.

### REFERENCE TO RELATED APPLICATIONS

This application claims priority from U.S. provisional application 60/977,580, filed on 4 Oct. 2007, and U.S. provisional application 61/047,659, filed on 24 Apr. 2008, the entire texts of each of which are incorporated herein by reference.

### STATEMENT AS TO FEDERALLY SPONSORED RESEARCH

Funding for the work described herein was provided through an NSF PHY 06-46094 and a R01 grant EB004626, both administered by the federal government, which may have certain rights in the invention.

### TECHNICAL FIELD

This disclosure relates to sensing biological targets and, more particularly, to systems that use magnetic resonance to measure quantities related to the detection of biological targets.

### BACKGROUND

The rapid and accurate measurement of biomarkers in biological samples provides information to quantify chemical entities, to facilitate early disease detection, and to gain insights into biology at the systems level. Techniques commonly used to analyze biological tissue include, for example, enzyme linked immunosorbent assay (ELISA), various forms of polymerase chain reaction (PCR), nanowire sensors and particles, surface plasmon resonance, and mass spectrometry. These techniques have a high sensitivity and are used in medical diagnosis, for example, to detect bacteria, circulating cells, or cancer biomarkers.

In addition, biological sensing can be performed using optical components, surface-structure based devices, whose operation relies on molecular diffusion of targets to sensing elements, or commercial nuclear magnetic resonance (NMR) systems, with or without the addition of contrast agents. One type of NMR contrast agent includes preparations of magnetic particles (e.g., nanoparticles) that are easily manipulated by weak applied magnetic fields and, ideally, have superparamagnetic properties. Such contrast agents typically affect the transverse relaxation rate (R2) and/or the longitudinal relaxation rate (R1) of a sample. The relaxation rate of a sample is equal to the inverse of the relaxation time of a sample: R2=1/T2 and R1=1/T1.

Magnetic particles have also been used to assay for analytes based on their ability to bind analytes and change magnetic resonance (MR) relaxation rates. For example, in U.S. Pat. No. 5,164,297, magnetic particles coated with bovine serum albumin (BSA) are used to react with an antibody. Addition of BSA favors dissociation of the complex between the antibody and the BSA-coated iron oxide particles. As a result of this dissociation of aggregates, the solvent R2 increases (T2 decreases), and the BSA concentration can be determined from R2.

### SUMMARY

The devices, systems, and techniques described herein relate to a chip-based, miniaturized NMR diagnostic platform for rapid, quantitative, and multi-channeled detection of biological targets.

For example, by using magnetic particles as a proximity sensor to detect molecular interactions with high sensitivity and selectivity, the described miniaturized NMR systems can perform high-throughput measurements in small volumes of unprocessed biological samples. These miniaturized NMR systems can be implemented with conventional microfabrication technology to provide a powerful, low-cost, and portable platform for high-throughput sensing.

In one aspect, the specification describes a miniaturized magnetic resonance system. The system can include, e.g., a permanent magnet, at least one microcoil, a microfluidic network that includes at least one cylindrical chamber and one or more three-dimensional channel networks, and a monolithic integrated circuit configured to transmit an excitation signal to a microcoil and to receive an input signal from a microcoil, and including a pulse generator and a low noise amplifier.

The pulse generator can include a digital pulse generator. The dimensions of the system can be less than about 30 centimeters by about 40 millimeters by about 2 centimeters. The circuit can include a heterodyne transceiver.

At least one amplifier can include a cascode structure. The system can include a variable gain amplifier. At least one amplifier can be a fully-differentiable amplifier. The system can include a voltage-controlled oscillator.

The magnet can have a field strength of about 0.5 T. Each of two poles of the magnet can be, e.g., no more than about 2 cm in width and the separation between the two poles can be, e.g., no more than about 2 cm. A plurality of magnets can be assembled as part of the system to produce a field strength greater than about 0.001 T.

The system can include at least one microcoil that is fabricated on a substrate, which can be a glass substrate.

The microfluidic network of the system can include heating elements with temperature sensors. The chamber of the system can be located on top of the at least one microcoil. A radius and a height of the chamber can be configured for a maximal NMR signal detection of a minimal sample volume for a given microcoil geometry.

The sample volume can be less than about 5 microliters.

The one or more three-dimensional channel networks of the system can mix a first input fluid and a second input fluid using chaotic advection. The first input fluid can include target molecules and the second input fluid can include conjugates that specifically bind to the target molecules.

The microfluidic network of the system can be patterned in a resin substrate. The microfluidic network can be attached to the circuit. The microfluidic network can further include a pumping system, which can be, e.g., an electrokinetic, a pneumatic, or a piezoelectric pump. The microfluidic network can include an embedded filter that concentrates a target from a sample.

In another aspect, the specification describes a method for detecting a target molecule in less than 10 microliters of a fluid sample. The method can include the following: obtaining conjugates that specifically bind to the target molecule, wherein each conjugate includes a nanoparticle that includes a magnetic metal oxide linked to a moiety that binds to the target molecule; contacting the conjugates with the fluid sample under conditions that enable the conjugates to bind specifically to any target molecules in the sample and form an aggregate of conjugates; obtaining at least two measurements of a relaxation property of the sample using a miniaturized nuclear magnetic resonance system, wherein the measurements are performed before and after at least one addition of the conjugates; and detecting an aggregate in the sample, wherein a presence of the aggregate indicates a presence of the target molecule.

A dynamic range of detection in the method can include, e.g., four orders of magnitude of target molecule concentration.

The method can detect, e.g., a concentration of at least 1 nanogram of the target molecule. The target molecule used in the method can include a biomarker, which can include a nucleic acid, a polypeptide, an enzyme, and/or a surface marker of a cell. The cell can be, e.g., a mammalian cell, a non-mammalian cell, a cancer cell, a stem cell, or an immune cell.

The fluid used in the method can include an optically transparent, translucent, turbid, or opaque fluid. The fluid can include water, saline, buffered saline, and/or a biological fluid. The method can detect at least one cell. The method can detect multiple biomarkers.

A decrease in spin-spin relaxation time (T2) in the method can indicate a presence of the target molecule.

In another aspect, the specification describes an assay method for detecting a target molecule in, e.g., less than 10 microliters of a fluid sample. The method includes the following steps: adding conjugates to less than 10 microliters of fluid sample, wherein each conjugate comprises a nanoparticle comprising a magnetic metal oxide linked to a moiety that binds to the target molecule; obtaining at least two measurements of a relaxation property of the less than 10 microliters of sample, using a miniaturized nuclear magnetic resonance system, wherein the measurements are performed before and after at least one addition of the conjugates; and detecting an aggregate in the less than 10 microliters of sample, wherein the presence of the aggregate indicates the presence of the target molecule.

In another aspect, the specification describes an assay method for simultaneously detecting target molecules in a plurality of samples, each less than 10 microliters. The method includes the following steps: obtaining conjugates, each including a nanoparticle that includes a magnetic metal oxide linked to a moiety that binds to the target molecules; obtaining a plurality of samples, each less than 10 microliters; forming a plurality of mixtures of the conjugates with each of the plurality of samples, such that the moiety binds to any target molecule in the plurality of samples; simultaneously measuring relaxation properties of each of the plurality of samples, using a miniaturized nuclear magnetic resonance system, before and after the addition of the conjugates; and detecting an aggregate in the plurality of samples, wherein a presence of the aggregate indicates a presence of the target molecules.

In another aspect, the specification describes a system for detecting a target molecule in less than 10 microliters of a fluid sample, including a miniaturized magnetic resonance system and a set of conjugates that specifically bind to the target molecule, wherein each conjugate comprises a nanoparticle comprising a magnetic metal oxide linked to a moiety that binds to the target molecule.

In another aspect, the specification describes an assay method for detecting a target molecule in less than 10 microliters of a fluid sample. The method includes the following steps: placing less than 10 microliters of the fluid sample in a first microfluidic channel; placing target-matched magnetic particles in a second microfluidic channel that joins with the first microfluidic channel; obtaining a mixture that has been mixed by chaotic advection of the sample and the magnetic particles within the first and second microfluidic channels; transferring the mixture to a microcoil array; and detecting an aggregate in the less than 10 microliters of sample, wherein the presence of the aggregate indicates the presence of the target molecule.

One advantage of these miniaturized NMR systems is that they do not require extensive purification of samples and can thus perform analyses in a shorter amount of time than other systems that require extensive purification of samples. Another advantage is that the miniaturized NMR systems can perform multiplexed measurements, which is desirable for analyzing complex diseases.

As used herein, “linked” means attached or bound by covalent bonds, non-covalent bonds, or other bonds, such as van der Waals forces.

As used herein, “specifically binds” means that one molecule, such as a binding moiety, e.g., an oligonucleotide or an antibody, binds preferentially to another molecule, such as a target molecule, e.g., a nucleic acid or a protein, in the presence of other molecules in a sample.

“Nutation” means an oscillation of the axis of a rotating object; specifically, the periodic variation of the inclination of a spinning magnetic moment that experiences a torque from an external magnetic field.

A “microcoil” is a small NMR probe that can be fabricated, for example, by forming a solenoid coil around a capillary tube or by creating a planar coil on a semiconductor or a glass substrate using microfabrication techniques. Such microcoils, whose inner diameters typically range in size between 0.1-0.5 mm (depending on the average size of the sample volume), are capable of obtaining high-quality NMR spectra with small sample volumes (nL-μL).

A “monolithic integrated circuit” is a miniaturized electronic circuit that is formed on the surface of a substrate (e.g., silicon, glass, metal, polymer, or combinations of such materials). In general, the term “monolithic” as used herein means that one or more components are manufactured on one substrate. Such an integrated circuit (IC) can be fabricated using various microfabrication techniques (e.g., photolithography, etching, or other techniques).

A “transceiver” is a device that contains both a transmitter and a receiver.

“Chaotic advection” describes the transport and mixing that occurs in fluid flows that are governed by nonlinear dynamics. The motion of individual particles of the fluid can be described by a system of ordinary differential equations, called the “advection equations.” For a system of steady flow, the advection equations are integrable and are classified as “regular advection.” For systems of unsteady flow, the advection equations may not be integrable and are characterized by “chaotic advection,” which can be understood as a particle motion that is sensitive to the initial conditions of a system.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description, the drawings, and the claims.

### DESCRIPTION OF DRAWINGS

FIG. 1A is a schematic of a miniaturized NMR system.

FIG. 1B is an exploded view of the miniaturized NMR system of FIG. 1A.

FIGS. 2A-C are additional implementations of NMR electronics.

FIGS. 3A-F are graphical simulations of RF magnetic field patterns generated in a microcoil as described herein.

FIG. 4 is a flowchart describing usage of a miniaturized NMR system.

FIG. 5 is a flowchart describing detection of a target within a sample using a miniaturized NMR system.

FIG. 6A is a schematic of monodisperse and clustered magnetic particles.

FIG. 6B includes graphs of T2 measurements in conditions of slow and fast proton relaxation.

FIG. 7 is a schematic representation of the steps for fabricating a microcoil used in a miniaturized NMR chip.

FIGS. 8A-D are schematics and graphs illustrating how characterizing measurements for the miniaturized NMR probe were made.

FIG. 8E is a graph illustrating the determination of 90° and 180° spin-flip pulse widths.

FIGS. 9A-B are graphs comparing the accuracy and sensitivity of the miniaturized NMR system to a benchtop system.

FIGS. 9C-D are graphs illustrating the detection range and sensitivity of the miniaturized NMR system.

FIGS. 10A-D are graphs of a measured NMR signal for two different densities of magnetic particles.

FIG. 11A is a graph illustrating a measured T2 dependence on the magnetic nanoparticle density.

FIG. 11B is a series of graphic representations and graphs of NMR measurements of magnetic particles conjugated to biotin, before and after the addition of avidin.

FIG. 12A is a schematic of magnetic particles binding to targets.

FIGS. 12B-C are graphs illustrating a measured T2 dependence on the magnetic nanoparticle density and target.

FIGS. 13A-B and E are electromicrographs of bacteria incubated with magnetic particles.

FIGS. 13C-D are graphs of NMR measurements of bacteria incubated with magnetic particles.

FIGS. 14A, B and D are graphs of NMR measurements of mammalian cells incubated with magnetic particles conjugated with antibodies or proteins.

FIG. 14C is a schematic of a microcoil array as used in a multiplexed NMR measurement.

Like reference symbols in the various drawings indicate like elements.

### DETAILED DESCRIPTION

The present invention provides a chip-based, miniaturized NMR platform, for example, for use in detecting various target molecules in samples (e.g., for diagnostic purposes). By adding samples and compositions that cause a specific interaction with target molecules (e.g., a nucleic acid, a polypeptide, a polysaccharide) within the sample, one can use this miniaturized NMR system for the rapid, quantitative, and multi-channeled detection of biological targets. For example, when a few magnetic particles bind to their intended molecular target via affinity ligands, they form soluble nanoscale clusters, which leads to a corresponding decrease in the bulk spin-spin relaxation time (T2) of surrounding water molecules.

The miniaturized NMR sensor strategy is based on a self-amplifying magnetic nanoparticle proximity assay. Importantly, because the assay uses magnetic resonance techniques for signal detection, measurements can be performed in turbid samples (e.g. blood, sputum, or urine) with little or no preparation steps.

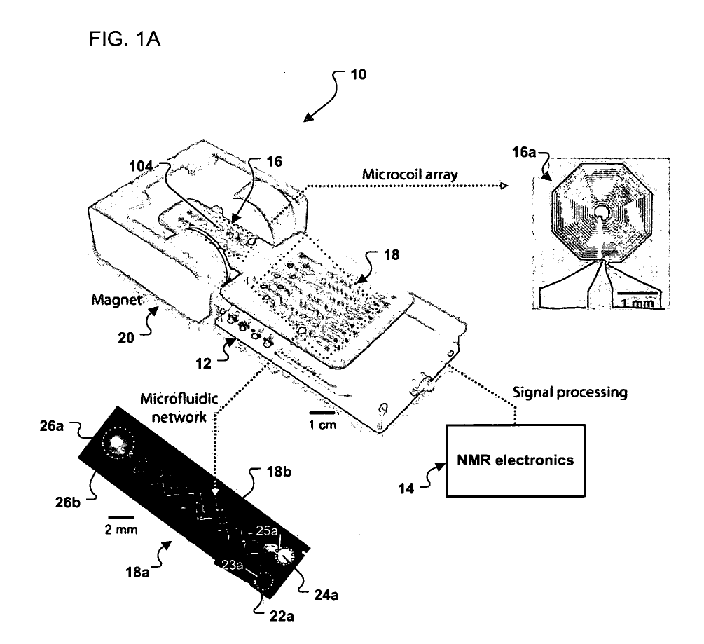

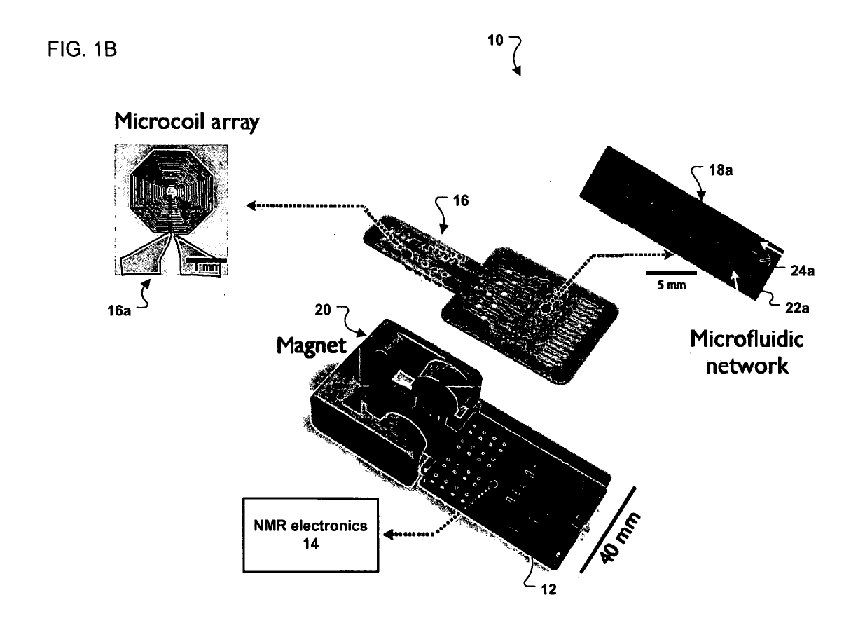

FIGS. 1A and 1B show the miniaturized NMR system 10 that includes a circuit board assembly 12, NMR electronics 14 (mounted on the circuit board assembly 12), a microcoil array 16, a microfluidic network 18, and a small permanent magnet 20. The miniaturized NMR system 10 can be an integrated, self-contained, and portable device. An exemplary miniaturized NMR system 10 can have a total length of less than about 30 cm (e.g., about 29 cm, 27 cm, 25 cm, 20 cm). Further size reductions may be possible by additional integration of the miniaturized NMR system components. The dimensions of the miniaturized NMR system 10 can be less than about 30 centimeters by about 40 millimeters by about 2 centimeters.

At least one microcoil, e.g., microcoil 16a, is part of the microcoil array 16, which can have multiple (e.g., two, four, six, eight, 10, 12 or more) microcoils. At least one winding channel (e.g., microfluidic channel 18a) is part of the larger microfluidic network 18, which can have multiple (e.g., two, four, six, eight, 10, 12 or more) microfluidic channels. The number of microfluidic channels can be chosen to equal the number of microcoils.

The microfluidic channel 18a has two distal ends, 23a and 25a, in which samples can be placed. For example, a sample 22a is placed in a distal end 23a and magnetic particles 24a that are designed to specifically bind to targets in the sample 22a are placed in a distal end 25a. The microfluidic channel 18a also has a proximal end 26a that is connected to the distal ends by a microfluidic trough 18b.

### NMR Electronics

In some embodiments, the NMR electronics 14 are formed on a monolithic integrated circuit, or a “chip.” In some embodiments, the NMR electronics 14 are mounted on a printed circuit board to form the circuit board assembly 12. In some embodiments, some circuitry of the NMR electronics 14 is formed on a chip and combined with other circuitry (e.g., impedance matching circuits, filtering circuits, acquisition circuits) that is off the chip. The printed circuit board can be fabricated by any known method in the art (e.g., silk screen printing, photoengraving, PCB milling, electroplating). The circuit board can be a single layer or multiple layers.

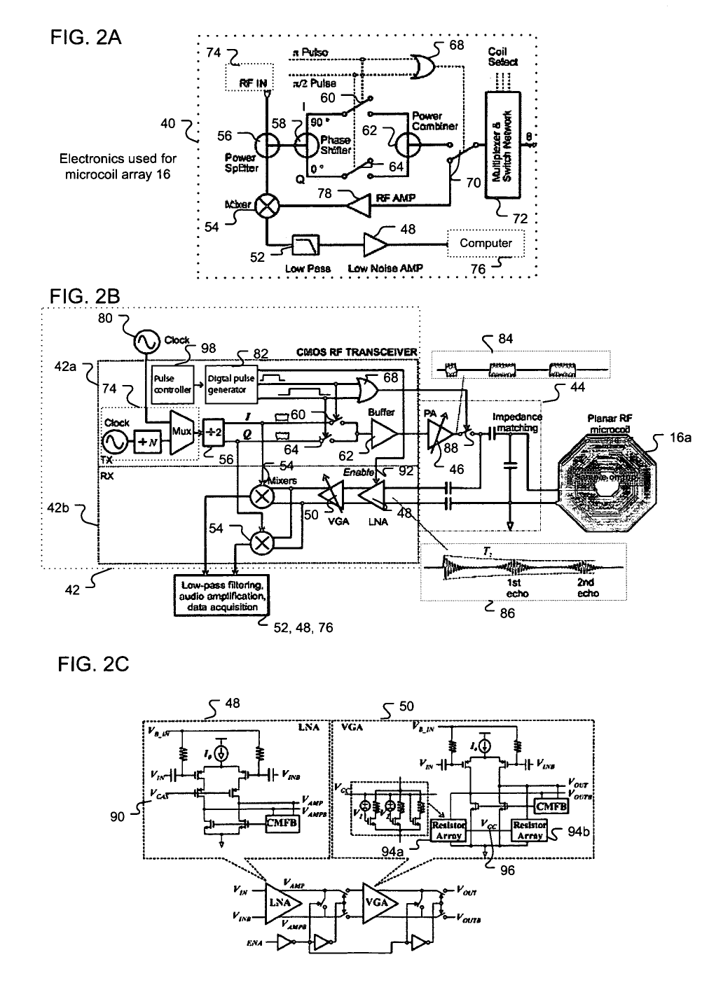

FIGS. 2A-C show the components of the NMR electronics 14. FIG. 2A is a schematic of the electronics used for the microcoil array 16. FIG. 2B is a schematic of the electronics used for a single microcoil (e.g., microcoil 16a). FIG. 2C is a schematic of the electronics of a low-noise amplifier (LNA) 48 and a variable gain amplifier (VGA) 50.

### Architecture Design Consideration

FIGS. 2A-B show schematics of a transceiver architecture according to aspects of the present invention. The complementary metal oxide semiconductor (CMOS) integrated circuit (IC) RF transceivers 40 and 42, each shown inside dashed boxes, contain various components (e.g., RF generator 74, mixer 54, low noise amplifier 48, power splitter 56, switch 60). The IC was fabricated in 0.18 μm CMOS.

The transceiver 42 is further divided into transmitting circuitry 42a and receiving circuitry 42b. The transmitting circuitry 42a of transceiver 42 interfaces coil 16a using an impedance matching network 44, which is enclosed by a dash-dotted box. A switch 88, located between the preamplifier (PA) 46 and the coil 16a, and an enable signal to the LNA 48 direct the coil between the transmitting and receiving modes.

A fully-differential, heterodyning receiver (e.g., receiving circuitry 42b of FIG. 2B or similar components in FIG. 2A) uses mixers (e.g., mixer 54). In some embodiments, mixer 54 can be a Gilbert mixer. The frequency of the local oscillator (quadrature signals I and Q, which represent, respectively, the imaginary and real components of the NMR signal) for heterodyning is tuned slightly off from an NMR signal frequency (e.g., NMR signal 86) by about 1 kHz. This frequency offset (mixer output frequency) is large enough to avoid direct current (DC) offset problems, but small enough to reject higher frequency noise. This scheme requires frequency synthesis with a 1-kHz resolution at the local oscillator. The chip has provisions for both on- and off-chip oscillators. The same I & Q signals used in the receiver are used as RF excitation signals in the transmitter (e.g., transmitting circuitry 42a of FIG. 2B or similar components in FIG. 2A). The aforementioned slightly-off excitation frequency (ωₒ/2π) is close enough to the resonance frequency to excite spins. The RF excitation signal (e.g., signal 84) is controlled (e.g., the width of excitation pulses is controlled) by a pulse controller (e.g., pulse controller 98) and is gated by a digital pulse generator (e.g., pulse generator 82). The quadrature excitation improves the quality of spin echoes (e.g., NMR signal 86).

The LNA 48 and the VGA 50 improve receiver sensitivity. Their schematics are shown in FIG. 2C. The dc blocking caps at the LNA 48 input reduce input offsets. The LNA is a differential cascade common source amplifier. At certain NMR frequencies, (ω_{O}/2π), (e.g., about 4.26 MHz, about 12.8 MHz, about 21 MHz, about 64 MHz, about 128 MHz, about 200 MHz, about 300 MHz), the overall noise from the LNA 48 is dominated by the channel thermal noise of the input transistors, which is decreased by increasing a tail current (e.g., 4 mA) and a gate width (e.g., 900 μm) or by increasing the size of the transistors. The large gate widths also reduce input offsets caused by device mismatches. Another type of noise, 1/f noise, can be reduced by using pmos transistors. Using pmos transistors also reduces substrate noise. The cascode structure of the LNA 48 mitigates the undesired feed-through of the local oscillator signal to the LNA 48 input, which can mask the true NMR signal. At some NMR frequencies, for example, 21 MHz, the voltage gain of LNA 48 is about 100, and its input referred noise is below 2.5 nV/Hz, which is the measured input referred noise of the receiver. To handle the wide range of the NMR signal power, a VGA 50, whose gain ranges from about 0.8 to 20, follows the LNA 48.

In the NMR transceiver system 40 or 42, a heterodyne transceiver architecture can be used, wherein the local oscillator frequency is set to be slightly off (e.g., about 1 kHz) higher or lower than the NMR signal frequency. Because the targeting NMR signal is a narrow band signal (e.g., about 4.26 MHz, about 12.8 MHz, about 21 MHz, about 64 MHz, about 128 MHz, about 200 MHz, about 300 MHz), this architecture can significantly reduce high-frequency noise and simplify the design of off-chip low pass filter and data acquisition systems, resulting in more accurate signal envelope extraction and T2 detection. Alternatively, the signal (e.g., NMR signal 86) can be directly amplified at the NMR frequency, or a homodyne transceiver can be used.

### Coil Excitation Signal and Mixer Local Oscillator Sharing Technique

Some embodiments utilize the same clock source (e.g., a clock 80, a clock within RF generator 74) for both the NMR coil excitation and the mixer down-conversion local oscillator (LO) signal. For a conventional NMR system, the transmitted signal is always at the same frequency as resonance frequency. If a heterodyne architecture is used, the LO frequency should be slightly off the resonance frequency, which means that two clock frequencies are necessary for these two parts and they should be accurately coupled to have a difference of about 1 kHz. This is very difficult to implement in real circuit design, but the same clock source can be used for coil excitation and LO, which significantly decreases the design complexity. This scheme does not cause a problem, because even an NMR signal frequency that differs slightly from the resonance frequency is still able to achieve nuclear spin resonance.

### Cascode Structure in the LNA to Enhance Isolation

In FIG. 2C, the LNA 48 is implemented with a cascode structure, which is formed by the two transistors whose gates are connected to signal V_{CAS} 90. The cascode structure is a technique to enhance the isolation between the input and output of the amplifier 48. In the new systems, this cascode structure mitigates the undesired feed-through of the LO signal to the LNA 48 input. The LO signal in the mixer can be coupled to the LNA 48 input through the parasitic capacitors in the mixer-VGA 50-LNA 48 path (See FIG. 2B). The cascode structure is necessary, because without it, the coupled signal to the LNA 48 input is much'larger than the received true NMR signal from the NMR coil. The cascode structure in the LNA 48 enhances the isolation from the output of the LNA 48 to its input, which reduces the coupling substantially and makes the coupled signal less than the true NMR signal.

### LNA Control Scheme

In FIG. 2B, the LNA 48 is controlled by an enable signal 92. In some embodiments, the coil (e.g., microcoil 16a) serves as both the excitation coil and the receiver coil. During the excitation mode, the receiver path should be disengaged so that a large transmitted RF signal to the coil is not fed into the receiver and amplified. One way to accomplish this is to put a switch before the LNA 48, but the turn-on resistance of a conventional switch (about a few ohms for off-chip switches and about tens of ohms for on-chip switches) contributes a large amount of noise to the receiver. In an alternative design, which can be used in the new miniaturized NMR system, the receiver path is shut down by disabling the LNA 48. Specifically, during the receiving mode, the enable signal 92 is high, and turns on two switches in the receiver path, allowing input NMR signals to be received by the receiver. During transmitting mode, the enable signal 92 is low, which turns off four switches (two switches are between the LNA 48 and VGA 50 and two switches are after the VGA 50) in the receiver path to disable receiving. At the same time, the switches between the two differential outputs of the LNA 48 and VGA 50 can be turned on, which substantially reduces the gain of the LNA 48 and VGA 50. Note that four switches in the receiver path also introduce turn-on impedance noise, but this does not contribute much to the overall noise, as the signals have been amplified by the LNA 48 or the combination of the LNA 48 and the VGA 50.

### VGA Scheme

A new variable gain amplifier (VGA) scheme is shown in FIG. 2C. The gain is tuned by adjusting the load of the amplifier (on the first order, the gain is linearly proportional to the effective load of the amplifier). Two resistor arrays, 94a and 94b, are introduced in the VGA 50, whose effective resistor is tuned by the V_{GC} signal 96. More specifically, depending on the value of V_{GC} 96, the three resistors inside the resistor arrays 94a and 94b are connected to the VGA 50 output nodes with different resistances. Thus, the overall output resistance of the VGA 50, or the gain of the VGA 50, is controlled by V_{GC} 96.

### Fully-Differential Structure for the LNA, VGA, and Mixer

In the new design, the LNA 48, the VGA 50, and the mixer can be fully differential, a technique that helps reduce the common-mode noise and improve rejection of the power supply noise.

### AC Coupling

In the new design, the signals are coupled through DC-blocking capacitors, which reduce the DC offset issues.

### Accurate Digital Quadrature Signal Generation

Because an accurate quadrature phase signal aids the accuracy of the Carr-Purcell pulse sequence, the new systems can use asymmetry divide-by-2 circuit 56 (See FIG. 2A), which can be set symmetrically to sense either a rising edge or a falling edge of an input signal, leading to accurate quadrature signal generation.

### Calibration of the Pulse Sequence

To compensate for potential process variations of the CMOS chip (i.e., the circuit parameters vary from chip to chip or from location to location on the same chip), a calibration of the Carr-Purcell pulse sequence parameters (e.g., pulse width, pulse interval, pulse number) can be performed with digital circuits.

### Using an On-chip Voltage-Controlled Oscillator

The new system can use a tunable clock source (e.g., the clock 80, the clock within RF generator 74) that can be tuned, for example, about 1 kHz below or above the NMR signal frequency. The NMR frequency varies with the slowly-moving static magnetic field (the permanent magnet), for example, due to temperature changes. To build a frequency synthesizer that meets this specification, a channel spacing is preferred that is less than or equal to a frequency that is dependent on the transmitting frequency (e.g., about 1 kHz at a 21 MHz reference frequency). However, if only the detected R2 change is important, as is the case, for example in a magnetic relaxation switch (MRS) application that involves substantial R2 differences between the sample without the target biomolecules and the sample with the target biomolecules, a voltage-controlled oscillator (VCO) with a reasonable phase noise can be used. In general, a VCO has a lower spectral purity performance (i.e., a larger phase noise) than a frequency synthesizer, but the VCO design is simpler.

### Microfluidics

The microfluidic systems used in the new miniaturized NMR system facilitate control and manipulation (e.g., separation, segregation) of small volumes of liquid and help isolate targets from a complex parent specimen.

During the sensing process, microfluidic elements provide vital functions, for example, handling of biological fluids, reproducible mixing of magnetic particles with samples, distribution of aliquots to different coils for parallel sensing, and confining of samples to the most sensitive region of a given microcoil.

The microfluidic channel 18a in FIG. 1A is a simplified example of a microfluidic system that includes a cylindrical chamber 104 atop a planar microcoil 16a and a meandering three-dimensional trough 18b. The branching trough 18b is designed to achieve complete mixing between magnetic particles (e.g., particles 24a) and analytes (e.g., sample 22a) at low Reynolds numbers (Re<0.1 in the experimental condition) by inducing chaotic advection in fluidic motion (as described, for example, in Xia, et al., Lab. Chip 5: 748-755, 2005). The cylindrical chamber 104, located on top of microcoil 16a, hold a sample to be analyzed. These chambers are designed to maximize the NMR signal level detected by a microcoil while minimizing the required sample volume. The optimal radius and height of the chamber were determined by the steps described below.

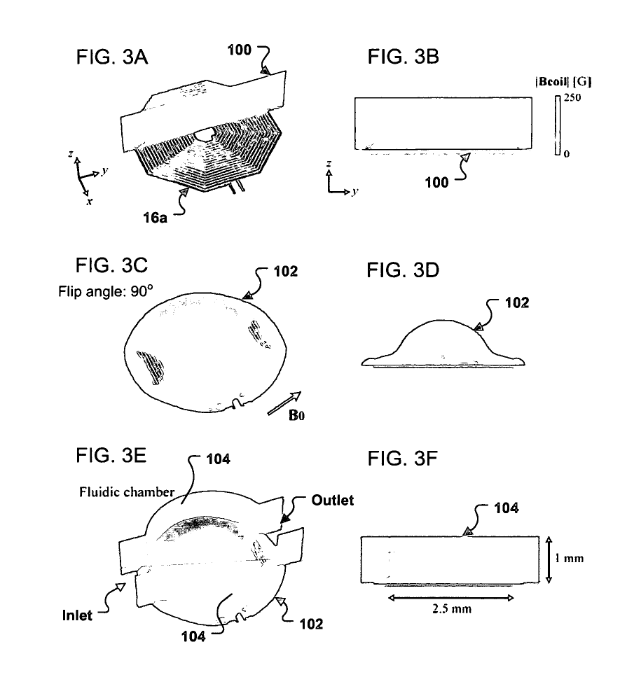

As shown in FIGS. 3A-F, by measuring a magnetic field profile 100 for a microcoil (e.g., microcoil 16a), the radius and the height of chamber 104 were designed for maximal NMR signal detection with minimal sample volume. Specifically, the magnetic field profile 100 (also called “Bcoil”) generated by a microcoil was numerically calculated using computational software (e.g., Maxwell 3D, Ansoft, PA) and assuming a unit current flow (1A). The microcoil used in the simulation has an outer radius of 1.25 mm. For clarity, the absolute value of Bcoil in the normal plane at the coil center is shown in FIGS. 3A-B. The field decreases rapidly as the distance from the coil center is greater than the coil radius.

Flip angles through which nuclear spins would be rotated, due to the applied magnetic field, were calculated using the following experimental conditions: main magnetic field strength=0.5 T in the y direction, 90° pulse width=40 μsec, and input power to the probe=0 dBm. Shown in FIGS. 3C-F is the volume 102 around the microcoil where the flip angle equals 90°. Target samples should occupy this area for maximal NMR signal detection by the microcoil. Depressions (hence the minimal contribution to the NMR signal) can be seen where Bcoil is parallel to the main magnetic field.

The final structure of the microfluidic chamber 104 was determined, shown in FIGS. 3E-F, based on the geometry of the volume 102. The radius of the chamber 104 is about r and the height was slightly less than r. The inlet and the outlet were laid out parallel to the main magnetic field over the depressed area in FIGS. 3C-D. The volume of the chamber was about 5μl and the NMR signal level, estimated via integration over the volume of chamber 104, was about 1 μV.

The channel networks provided effective fluid mixing through chaotic advection between different input fluids. For fast prototyping, microfluidic systems can be prepared by patterning a substrate (e.g., polymethylmethacrylate) using, for example a CO₂ laser. Depending on the experimental purposes, different microfluidic systems can be attached to the micro NMR chips. For example, fluid pumping systems (e.g., electrokinetic, pneumatic, piezoelectric) or filtering systems can be embedded to size-selectively concentrate targets (e.g., bacteria, cells) from a large volume of specimen. In addition, auxiliary functions of bacteria culture or cell treatment (e.g., incubation with particles or drugs, lysis of a cell, both techniques are described in El-Ali, et al., Nature 442:403-411, 2006) or other functionalities can be implemented.

In some embodiments, heating elements with temperature sensors can be incorporated into the microfluidic system to control the temperature of the sample.

### Microcoil Array

Array-based microcoils can be used, rather than field gradient coils, to miniaturize the device and to perform higher throughput operations. Because the sensing components are small, portable permanent magnets can be used to generate a strong, polarizing magnetic field (e.g., about 0.001 T, 0.1 T, 0.3 T, 0.5 T, 1.5 T). The sensor can be tuned to operate at a polarizing magnetic field (e.g., about 0.5 T or 21.3 MHz) that is generated by a portable permanent magnet.

The miniaturized NMR system 10 can have a number of microcoils in the microcoil array 16. For example, the microcoil array 16 can include eight planar microcoils, each similar to microcoil 16a.

These microcoils can be fabricated by any known method, such as complementary metal oxide semiconductor (CMOS) compatible microfabrication technology, deposition or growth techniques (e.g., thermal oxidation, sputtering, evaporative deposition, chemical vapor deposition, epitaxy, electroplating), patterning techniques (e.g., photolithography, shadow masking, focused-ion-beam milling, electron-beam lithography, microcontact printing), or etching techniques (e.g., plasma etching, chemical etching). The microcoils can be fabricated on any suitable substrate, such as glass, ceramic, silicon, sapphire, polyimide film (e.g., Kapton®), Teflon®, or gallium arsenide. The microcoils can transmit RF (radio frequency) signals to the sample as well as receive NMR signals from the sample. In other embodiments, a volume coil can transmit RF excitation pulses and microcoils (e.g., microcoil array 16) can detect NMR signals.

By the application of a DC current, the microcoils can also be used to environmentally heat samples and to concentrate magnetically-labeled targets by forming magnetic traps.

### Use of Magnetic Particles

### Particles

Magnetic particles include one or more inner magnetic cores and an outer coating, e.g., a capping polymer. The magnetic cores can be monometallic (e.g., Fe, Ni, Co), bimetallic (e.g., FePt, SmCo, FePd, FeAu) or can be made of ferrites (e.g., Fe₂O₃, Fe₃O₄, MnFe₂O₄, NiFe₂O₄, CoFe₂O₄). The magnetic particles can be nanometers or micrometers in size, and can be diamagnetic, ferromagnetic, or superparamagnetic. The outer coating of a particle increases its water-solubility and stability and also provides sites for further surface treatment with binding moieties.

### Binding Moieties

Binding moieties include functional groups or parts of molecules that participate in chemical bindings. For example, streptavidin has four sites (binding moieties) per molecule that will be recognized by biotin.

### Conjugate Preparation

The surface of the magnetic particles are treated to present functional groups (e.g., —NH₂, —COOH, —HS, —CₙH₂ₙ₋₂) that can be used as linkers to subsequent attachments of other molecules (e.g., antibodies, drugs). More details are provided in the examples below.

### Selectivity

By conjugating magnetic particles with binding moieties (e.g., biotin, monoclonal antibody) that will specifically bind to intended targets, a high selectivity can be achieved to enhance the accuracy of the miniaturized NMR system assay.

Consider, for example, magnetic particles with surfaces coated with biotin (a vitamin) that specifically bind to avidin (a protein). If avidin exists in a sample, the coated magnetic particles suspended in the sample will self-assemble into clusters. The clustering can be sensed, and the presence of avidin inferred, because the clusters (as opposed to individual, unclustered particles) introduce greater local magnetic field modulations and therefore reduce T2. This detection scheme, which is referred to herein as a “magnetic relaxation switch,” is a general sensing modality that can detect a variety of target biomolecules (e.g., proteins, viruses, cancer markers) by using magnetic particles with surfaces modified with binding moieties that specifically bind to the target objects.

### Use of Miniaturized NMR Systems

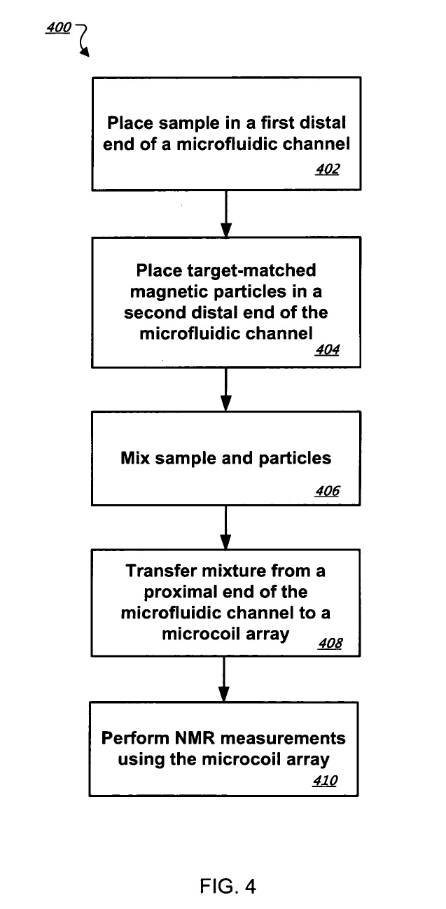

A flowchart 400 in FIG. 4 describes a series of steps for using the miniaturized NMR system 10 to perform measurements. For example, in a first step 402, a sample to be measured (e.g., sample 22a) is placed in a first distal end (e.g., distal end 23a) of a microfluidic channel (e.g., channel 18a). In a second step 404, magnetic particles 24a that specifically bind to a target are placed in a second distal end (e.g., distal end 25a) of the microfluidic channel (e.g., channel 18a). The meandering trough 18b is arranged so that sample 22a and magnetic particles 24a will experience chaotic advection, causing the sample 22a and the magnetic particles 24a to mix (step 406) as both substances flow from the distal ends, 23a and 25a, to the proximal end 26a and to the cylindrical chamber 104 above the microcoil (e.g., microcoil 16a).

In step 408, syringe pumps transfer the combined target sample 22a and magnetic particles 24a (e.g., fluid 26b) from the proximal end 26a of the microfluidic channel 18a to the microcoil array 16 (e.g., by means of pressure-driven flow). In other embodiments, other types of pumping systems can be embedded in the miniaturized NMR system 10 and used for fluid delivery. Known pumping methods include, for example, electrokinetic pumping (as described, for example, in Trumbull, et al., IEEE Transactions on Biomedical Engineering 47(1):3-7, 2000), piezoelectric pumping (as described, for example, in Bu, et al., Sensors and Actuators A 115(2-3):476-482, 2004), or pneumatic pumping (as described, for example, in Melin and Quake, Annu. Rev. Biomol. Struct. 36:213-231, 2007). Once the mixture is in the microcoil array 16, NMR measurements are performed in step 410.

NMR electronics provide pulse sequences to measure a longitudinal relaxation time (T1) and a transverse relaxation time (T2). The T1 of a sample can be measured using inversion recovery (IR) pulse sequences; the T2, Carr-Purcell-Meiboom-Gill (CPMG) spin echo pulse sequences. The pulse widths required to cause a 90° and a 180° rotation of nuclear spins are determined by generating nutation curves for each microcoil.

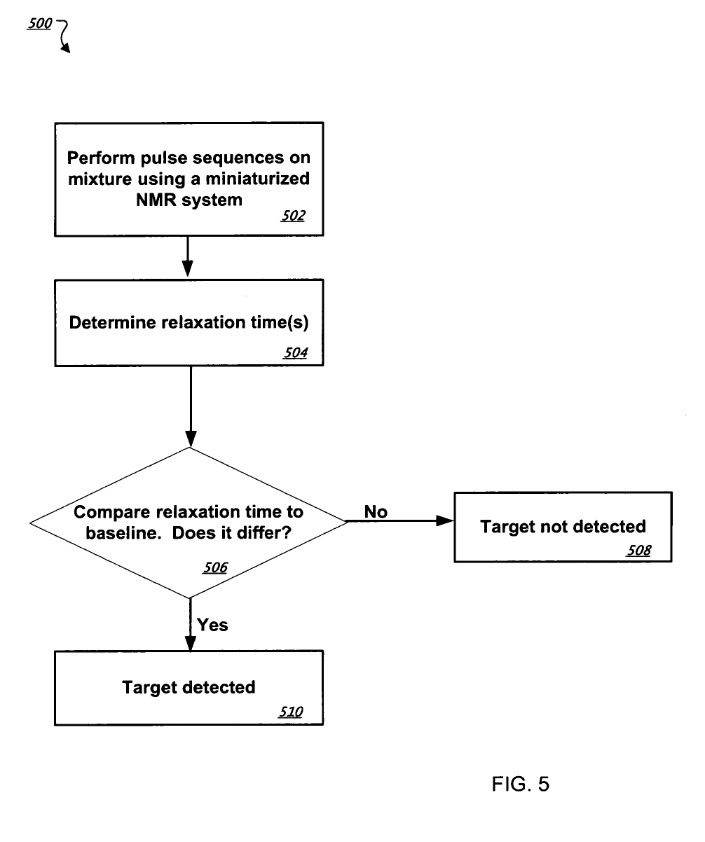

A flowchart 500 in FIG. 5 describes a series of steps for using the miniaturized NMR system 10 to determine whether or not a target is present in a sample 22a. Pulse sequences (e.g., IR, CPMG, Carr-Purcell) are performed on a mixture and data is acquired using a miniaturized NMR system (step 502). The relaxation time or times for each mixture (e.g., the combination of sample 22a and magnetic particles 24a) are determined (step 504) using the acquired data. The calculated relaxation time or times for each mixture is compared (step 506) to a baseline relaxation time or times of the magnetic particles (e.g., particles 24a) that do not have attached targeting moieties. The baseline relaxation times could be measured or could be obtained from a reference. If the measured relaxation time or times of the mixture do not differ from the baseline time, the target is not detected (step 508). If the measured relaxation time or times of the mixture are different from the baseline time, the target is detected (step 510).

For example, to detect vascular endothelial growth factor (VEGF) in solution, two samples are prepared: magnetic particles without targeting molecules (e.g., CLIO-NH₂) and magnetic particles that are conjugated to targeting molecules (e.g., CLIO-antibody-to-VEGF). First, the CLIO-NH₂ particles are mixed with VEGF and a baseline measurement of T2 is obtained. Next, the CLIO-antibody-to-VEGF particles are mixed with VEGF and a second measurement of T2 is obtained. A difference in T2, or AT2, is calculated by subtracting the second T2 measurement from the baseline T2 measurement.

Next, to produce a calibration curve for detection, a known amount of target entities (e.g., VEGF) is spiked and ΔT2 is measured for each concentration, as described above. These experiments are then repeated with different amounts of targets to generate a calibration curve.

In alternative embodiments, a different method of calibration can be used that consists of the measuring the T2 of three samples: a target sample (e.g., blood, serum), magnetic particles that have been conjugated to binding moieties, and magnetic particles that have not been conjugated to binding moieties.

In alternative embodiments, the baseline T2 can be a known, standard quantity (e.g., the relaxation rate or rates of blood free from pathogens or disease).

### Applications

The sensitivity of measurements made with the miniaturized NMR system is improved by i) designing microcoils with a specific geometry, ii) reducing the electrical resistance of the microcoils, iii) reducing external interferences and signal loss by monolithically integrating the signal detection circuitry along with microcoils in a single IC (integrated circuit) chip, iv) designing magnetic particles with higher R2 relaxivity, and v) increasing the NMR signal-to-noise ratio through novel assemblies of permanent magnets to generate higher polarizing magnetic fields.

These improvements enable the manufacture of a fully-integrated miniaturized NMR system in which the microcoils and detection circuitry are implemented into a single IC chip, creating a wide detector array for high-throughput and low-cost operation.

The new miniaturized NMR systems described herein can be used for diagnostic testing near a patient (so called “point-of-care” testing). For example, the miniaturized NMR system can be handheld and can be used in an ambulance, in an emergency room, in an intensive care unit, or in other patient settings for the rapid, quantitative, and multi-channeled detection of biological targets. Example detection targets are discussed in more detail below and in the Examples section.

### Detecting Infectious Agents

Many different infectious pathogens (e.g., viruses, bacteria, fungi, parasites) can be easily detected with the new systems with minimal preparation steps (e.g., no need for intensive purification steps). The miniaturized NMR system measurement is fast (e.g., less than 30 min) and simple compared to conventional detection methods (e.g., a culture-based method, a PCR-based method).

### Mammalian Cells

Primary tumor cells or circulating tumor cells can be targeted with magnetic particles and can be detected using the new miniaturized NMR system for a rapid and comprehensive profiling of cancers. By changing binding molecules on the particle surface, different types of cells can be detected (e.g., circulating endothelial cells for heart disease). Thus, miniaturized NMR can be used as a powerful diagnostic and prognostic tool.

The targeted and detected cells could be cancer cells, stem cells, immune cells, or other cells.

### Detection Assays

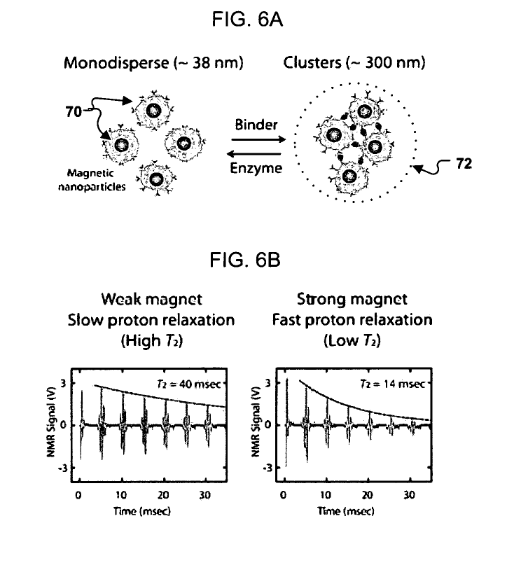

FIGS. 6A-B illustrate the principle of proximity assay detection using magnetic nanoparticles. When monodisperse magnetic particles cluster after binding to a target, as in FIG. 6A, the self-assembled clusters become more efficient at dephasing nuclear spins of surrounding water protons, leading to the decrease of spin-spin relaxation time (T2).

FIG. 6B shows an example of the proximity assay measured by the miniaturized NMR system. Avidin was added to a solution of biotinylated magnetic particles, causing T2 changes from 40 msec to 14 msec.

### Multiplexed Detection

Detecting multiple biomarkers in one parent sample is an important and highly-desirable task for diagnosis and prognosis of complex diseases. For example, there is no ubiquitous biomarker for cancer; multi-channeled screening is required to correctly identify tumor types. The miniaturized NMR system offers a method to detect different relevant biomarkers from the aliquots of a single, parent sample, e.g. in patients with cancer or metabolic disorders. The miniaturized NMR system is well-suited for this application because many sensors (e.g., microcoils) can be accommodated on a small area as an array format, and only a small volume of a sample is consumed per measurement.

### EXAMPLES

The invention is further described in the following examples, which do not limit the scope of the invention described in the claims.

### Example 1

### Microfabrication of Microcoils

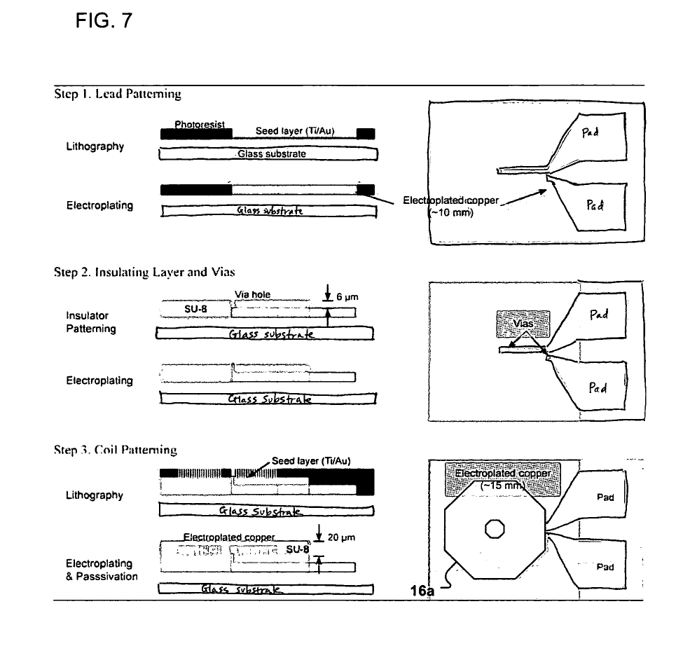

The microcoils in the miniaturized NMR system were fabricated using standard microfabrication techniques. To minimize the signal loss and reduce electrical noise, glass wafers were used as a substrate and metal lines were electroplated with copper. FIG. 7 shows the steps in the microcoil fabrication process. An elevation/side view is shown on the left side of the figure, and a top view is shown on the right side of the figure.

Step 1: Electrical leads were patterned by lithography, followed by metal deposition (Ti/Au 10 nm/100 nm). After removing the metal, the same electrical lead pattern was structured again using a thick photoresist (SPR220-7; MicroChem, MA), which served as a plating mold. The leads were then electroplated with copper to a thickness of 10μm. A plating solution was mixed in-house (CuSO₄.H₂O 75 g/1, 35% H₂SO₄ 286 m1/1, 35% HCl 0.13 ml/l) and a plating current density of about 15 mA/cm² was used. To achieve a uniform plating, the plating solution was agitated by injecting air bubbles and by stirring.

Step 2: As a first insulating layer, an epoxy-based resin (SU-8 2005; MicroChem, MA) was spin-coated (thickness 6 μm) and “via holes” were defined by lithography. To enhance its structural integrity, the patterned SU-8 layer was hard-cured at an elevated temperature (200° C.) for 30 minutes. After the thermal cure, via holes were filled with copper by electroplating.

Step 3: Coil windings were patterned by lithography, and metal layers (Ti/Cu 10 nm/200 nm) were deposited on top of the first insulating layer. Following the removal of metal, the same coil windings were structured again using a thick photoresist, as in Step 1, to make a plating mold. The coil windings were then copper-electroplated up to a thickness of 15 μm. Another SU-8 layer (SU-8 2015; MicroChem) was spun, patterned, and hard-cured to form a second insulating layer having a thickness of 20 μm.

After a glass wafer was formed, it was diced into chips. Microfluidic structures were attached using a UV-curable adhesive (NOA61, Norland Products, NJ).

This example illustrates a fabrication process for microcoils that can be used in the miniaturized NMR system.

### Example 2

### Electrical Characterization and Impedance Matching of Microcoils

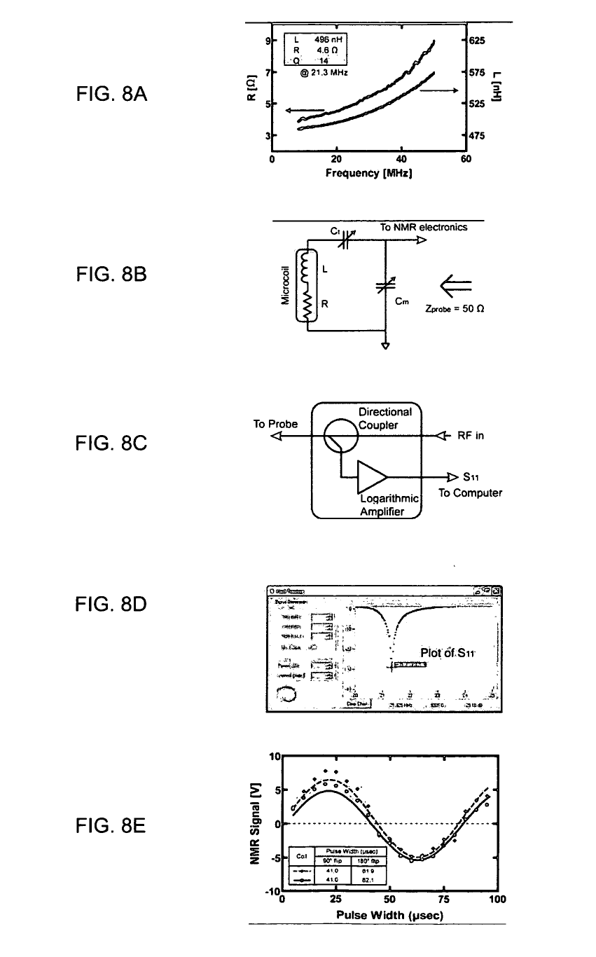

Electrical properties of the microcoils can be measured using a network analyzer. FIGS. 8A-D show a measured performance of a microcoil. Specifically, FIG. 8A shows measurements performed on a network analyzer. At an NMR frequency of 21.3 MHz, the microcoil has an electrical resistance of 4.6Ω and an inductance of 496 nH, giving a high quality factor Q=14. Parasitic capacitance was negligible up to a frequency equal to about 800 MHz. Microcoils formed on a single wafer showed similar electrical properties with variations less than 5%. Shown in FIG. 8B, the impedance of microcoils was matched to that of the RF electronics (50Ω) for an effective energy transfer. A capacitively-coupled tank circuit can be formed by connecting two variable capacitors to a microcoil (e.g., microcoil 16a); this forms an NMR probe, and the impedance of the probe can be transformed to 50Ω by an appropriate tuning of the capacitors that depends on the NMR signal frequency. FIGS. 8C-D illustrate schematically a custom-built reflectometer, using a directional coupler (ZFDC-15-6; Mini-circuits, NY) and a logarithmic amplifier (AD8306; Analog Devices, MA). The reflectometer facilitates the matching process and reports the level of reflected RF voltage (S11 in dB) from the probe; when the impedance of the probe matches that of RF source, the S11 has a minimum value (FIG. 8D).

To perform relaxation measurements using inversion-recovery and CPMG echo sequences, it was necessary to determine the excitation pulse widths for 90° and 180°pulses. For each microcoil, the pulse widths required to experimentally achieve 90° and 180° rotations of spins were determined by measuring an NMR signal versus the varying excitation pulse width. While the RF power input to the probe was fixed to 0 dBm, the excitation pulse width was swept and the maximum amplitude of the resulting free induction decay (FID) was monitored, generating a nutation curve for each microcoil (FIG. 8E). The curves were numerically fit to a sine function to obtain each pulse width. The variations of pulse widths among microcoils were small, confirming that microcoils fabricated from one wafer have similar electrical properties.

This example illustrates a tuning procedure for microcoils. It is important to have a robust and appropriate tuning procedure to ensure consistent measurements of the miniaturized NMR system that achieves the greatest signal to noise ratio from the microcoils.

### Example 3

### Benchmarking the Miniaturized NMR System

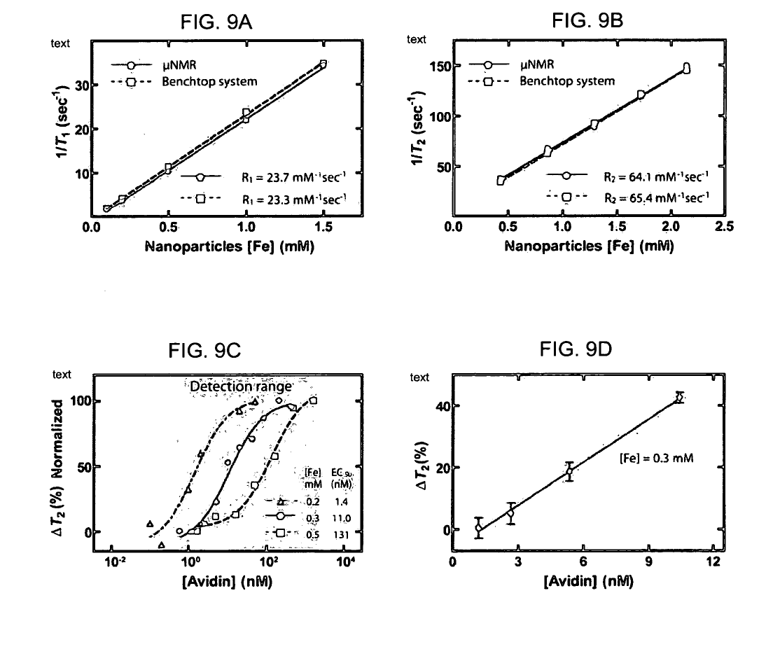

To determine its accuracy, the miniaturized NMR system was benchmarked against a large benchtop NMR relaxometer operating at a similar main magnetic field (0.47 T or 20 MHz). The benchtop system required sample volumes greater than 300 μL and was able to process one specimen at a time, whereas the sample volume for the miniaturized NMR system was less than 5μL and the number of simultaneous measurements was limited only by the number of coils per chip. FIGS. 9A-B show that the observed longitudinal (R1) and transverse (R2) relaxivities of water that contained magnetic particles agreed very well between the miniaturized NMR system and the benchtop relaxometer (p<0.0001).

Increasing amounts of avidin were added to biotinylated magnetic particles, which led to the formation of larger clusters and concomitant decreases in T2 of the surrounding water. By varying the concentration of magnetic particles, detection dynamic ranges spanning up to four orders of magnitude were observed (as shown in FIG. 9C). Compared to the benchtop relaxometer, the miniaturized NMR system showed two orders of magnitude improved mass detection limit: the benchtop relaxometer detected about 80 ng (1.2 μmol) of avidin, whereas the miniaturized NMR system had a detection limit of about 1.0 ng (15 fmol), achieving an increase in mass-sensitivity of about 80 (FIG. 9D). The enhanced sensitivity of the miniaturized NMR system can be attributed to a microcoil that produces strong RF magnetic fields per unit electrical current, microfluidic systems that place target samples in the most sensitive regions within the microcoils (thereby increasing the filling factor), and a miniaturization of the whole system that allows smaller sample volumes to be tested. The miniaturized NMR system is thus well suited to conserve sample size, to detect analytes in mass-limited biological samples, and to preserve expensive analytes.

This example serves to validate the accuracy of the miniaturized NMR system by comparison with a large benchtop NMR relaxometer.

### Example 4

### Preparation of Magnetic Particles

1-ethyl-3-(3-dimethylaminopropyl) carbodiimide hydrochloride (EDC), and sulfosuccinimidyl ester of N-hydroxysuccinimide (sulfo-NHS) were purchased from Pierce Biotechnology Inc., IL.; N-succinimidyl 3-(2-pyridyldithio) propionate (SPDP) was purchased from Molecular Biosciences Inc., CO. All other chemicals, unless specified otherwise, were purchased from Sigma Aldrich Inc., MO, and used as received. Separation columns, PD-10 and Sephadex® G-25, were purchased from GE Healthcare Bio-Sciences, NJ.

a) Synthesis of Magnetic Particles (CLIO-NH₂)

Details on the synthesis of magnetic particles have been reported, for example, in Josephson, et al., Bioconj. Chem. 10:186-191, 1999. In brief, a monocrystalline magnetic nanoparticle, with a 3-nm core of (Fe2O3)ₙ(Fe3O4)ₘ was covered with a layer of 10 kDa dextran, cross-linked with epichlorohydrin and aminated to provide primary amine groups (CLIO-NH₂). On average, 36 primary amines were available per nanoparticle for further conjugation. The number of amines was determined by reaction with SPDP and treatment with dithiothreitol that releases pyridine-2-thione (P2T). The diameter of the nanoparticle in aqueous solution is 38 nm with R1=21 mM⁻¹ sec⁻¹ and R2=62 mM⁻¹ sec⁻¹ (at 37° C. and 0.5 T).

b) CLIO-Biotin Synthesis

To biotinylate CLIO-NH₂, 200 μl (3.8 mg, 8.4μmol) of LC-Biotin (00391, Molecular Biosciences) in dimethyl sulfoxide (DMSO) was added to 3.5 ml (9.3 mg/ml Fe) of CLIO-NH₂ in phosphate buffered saline (PBS) at a pH of 7.4. The mixture was allowed to react for 60 minutes at room temperature. Free chemicals and by-products were then removed with dialysis on a PD-10 column equilibrated with 20 mM of sodium citrate (Na₃C₆H₅O₇) and 0.15 M of NaCl at a pH of 8.0. The biotin-to-CLIO ratio (18:1) was derived by subtracting the number of NH₂ of the products from the initial concentration of CLIO-NH₂.

c) CLIO-Vancomycin Synthesis

CLIO-NH₂ was reacted with succinic anhydride in 0.1M of sodium carbonate buffer, at a pH of 9.3 and at room temperature for 4 hours to convert surface amine groups to carboxylic groups. After purification, carboxylated CLIO (CLIO-COOH) was stored in a MES buffer (50 mM MES, 0.1M NaCl) at a pH of 6.0 and at a concentration of 5.0 mg/mL Fe. To react with vancomycin, an aliquot of CLIO-COOH (200 μL) solution was first reacted with EDC (0.96 mg, 5 μmol) and sulfo-NHS (1.1 mg, 5 μmol) at room temperature for 60 minutes. The mixture was then purified through a Sephadex G-25 column eluted with PBS, at a pH of 7.4. Subsequently, 100 μL vancomycin (50 mM) in PBS solution was added to the EDC-activated CLIO solution. The mixture was allowed to react for 2 hours at room temperature. Free vancomycin was removed by a Sephadex G-25 column eluted with PBS, at a pH of 7.4.

d) CLIO-Glucose Synthesis

CLIO-NH₂ was converted to CLIO-COOH as described above. After purification with Sephadex G-25, CLIO-COOH was stored in a MES buffer (50 mM MES, 0.1M NaCl) at a pH of 6.0 and at a concentration of 5.0 mg/mL Fe. To attach glucose, 200 μL of a CLIO-COOH solution was first reacted with EDC (0.96 mg, 5 μmol) and sulfo-NHS (1.1 mg, 5 μmol) at room temperature for 60 minutes. The mixture was then purified through a Sephadex G-25 column eluted with PBS, at a pH of 7.4. Subsequently, 100 μL of 2-glucosamine hydrochloride in distilled water (50 mM) was added and reacted for 2 hrs at room temperature. Unreacted glucosamine was separated by a Sephadex G-25 column eluted with PBS, at a pH of 7.4.

e) CLIO-Folic Acid Synthesis

CLIO-NH₂ was prepared in a PBS buffer, at a pH of 7.4, and was first exchanged with an MES buffer (50 mM MES hydrate, 0.1M NaCl) at a pH of 6.0. The solution was concentrated to 5.0 mg/mL Fe. Then 100 μL (50 mM) of folic acid (FA) in DMSO was added to 200 μL of CLIO-NH₂ (5.0 mg/mL Fe) in an MES solution at a pH of 6.0, followed by the addition of excess EDC (0.96 mg, 5 μmol) and sulfo-NHS (1.1 mg, 5 μmol) in 100 μL of DMSO. The reaction proceeded at room temperature for 2 hours and the product was purified through a Sephadex G-25 column and eluted with PBS at a pH of 7.4. The attachment of FA was quantified by calculating the loss of amine groups using SPDP and was measured to be 33 attachments of FA per 2,000 Fe.

f) Synthesis of Antibody-Conjugated CLIO

Table 1 lists the antibodies attached to magnetic particles for biomarker detection. To conjugate antibodies, CLIO-NH₂ was first converted to CLIO-COOH as described above. After purification through a Sephadex G-25 column, the CLIO-COOH was stored in an MES buffer (50 mM MES, 0.1M NaCl) at a pH of 6.0 and at a concentration of 5.0 mg/mL Fe. To attach an antibody, 200 μL of a CLIO-COOH solution was reacted with EDC (0.96 mg, 5 μmol) and sulfo-NHS (1.1 mg, 5 μmol) at room temperature for 60 minutes. The mixture was purified through a Sephadex G-25 column eluted with PBS, at a pH of 7.4. Subsequently, 500 μl of an antibody in PBS (1 mg/ml) at a pH of 7.4 was added and reacted for 2 hours at room temperature. The final product was purified with a Sephadex G-50 column and eluted with PBS at a pH of 7.4. On average, each nanoparticle had 2 antibodies attached.

TABLE 1
List of Antibodies Conjugated to Magnetic Particles

| Target | Antibody | Catalog #, Vendor |
|---|---|---|
| CD326 | Monoclonal | Ab11294, AbCam, MA |
| Her2/Neu | Trastuzumab | Herceptin, Genentech, CA |
| EGFR | Cetuximab | Erbitux, ImCone Systems, NY |
| VEGF | Bevacizumab | Avastin, Genentech, CA |
| CA125 | Monoclonal | Ab10033, AbCam, MA |
| AFP | Monoclonal | Ab3980, AbCam, MA |

This series of examples illustrates the preparation of magnetic particles, an important component of the detection capability of the miniaturized NMR system.

### Example 5

### Estimating the Concentration of Target Molecules

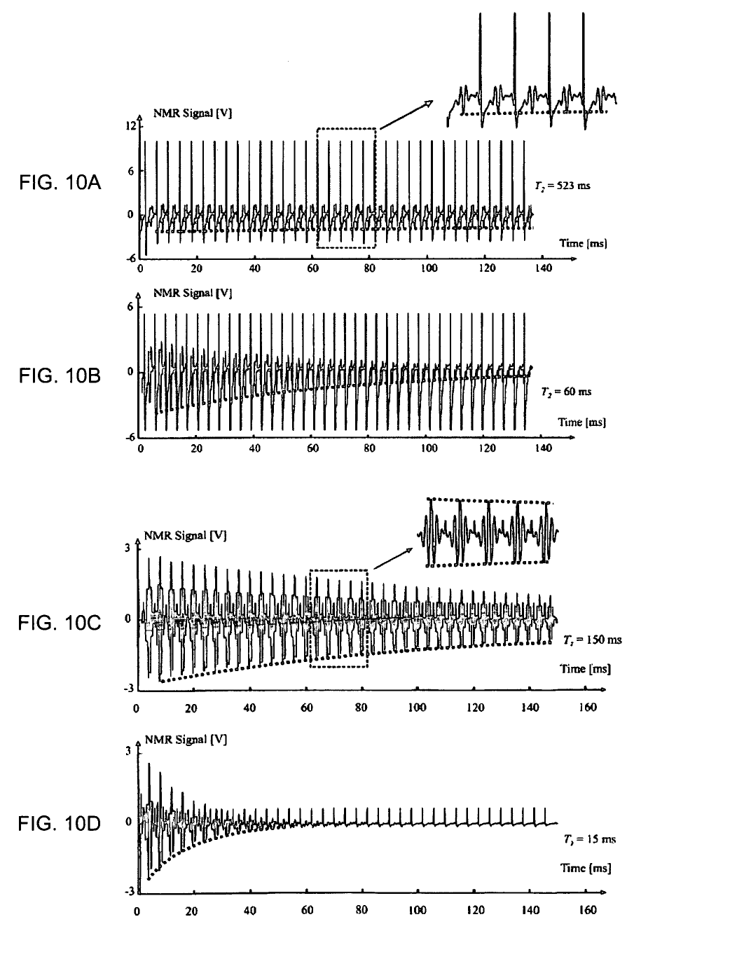

FIG. 10A shows a measured NMR signal of a 5 μL sample of PBS, which is essentially isotonic & biocompatible water. The signal is produced after a Carr-Purcell excitation and is a train of attenuated spin echoes. A T2 of 523 ms was calculated from the exponentially-decaying envelope (dotted line) of the spin echoes. The repeated spikes represent a coupling of the transmitted RF sequence to the receiver. As magnetic particles each having a diameter of (about 30 nm) are put into the PBS solution, they introduce spatial and temporal modulations on top of the main magnetic field, B₀, and intensify the loss of phase coherence in spin precessions, thereby decreasing T2. As shown in FIG. 10B, after magnetic particles (with a concentration of about 0.17 mM) are added to the PBS solution, T2 reduces to 60 ms. The measured T2 with various densities matches the theory, validating the relaxometry function of the miniaturized NMR system.

In addition to performing experiments with the planar microcoil (Q: 16, L: 500 nH), which was used to obtain the results shown in FIGS. 10A-B, a similar experiment was performed using a higher-Q solenoid microcoil (Q: 200, L: 300 nH) to show the spin echoes more clearly. With a higher-Q coil, the spin echoes are more apparent than the spikes (FIGS. 10C-D). As the magnetic particle density was changed from 0.1 mM to 1 mM, T2 was reduced from 150 ms to 15 ms (FIGS. 10 C-D).

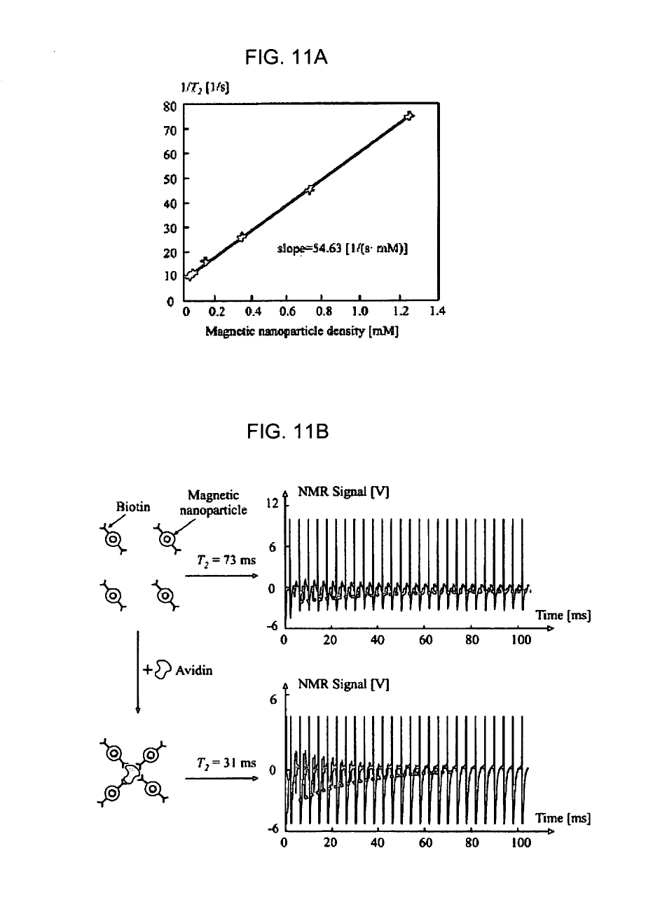

FIGS. 10A-B show the measured T2 relaxation times of water (PBS) at two different magnetic particle densities (0 and 0.17 mM). The T2 relaxation time at other various particle concentrations were also measured with both the miniaturized NMR system and a benchtop system. As shown in FIG. 11A, the slope calculated from measurements with the miniaturized NMR system was about 55 (s·mM)⁻¹. This value is consistent with the result of about 56 (s·mM)⁻¹ calculated from measurements with a commercial benchtop system. These measurements are also consistent with basic NMR theory, which states that 1/T2 should be linearly proportional to the particle concentration.

FIG. 11B shows the measured T2 relaxation times of a mixture of biotin and magnetic nanoparticles before (T₂=73 ms) and after (T₂=31 ms) the addition of avidin. These measurements were performed with the miniaturized NMR system and illustrate an example of the magnetic relaxation switch, which is described in more detail in the following example.

This example further confirms the accuracy of measurements performed by the miniaturized NMR system.

### Example 6

### Detection of Avidin Aggregates

To demonstrate biological application for the miniaturized NMR system, avidin-biotin interactions were characterized. We now elaborate on the principle of the magnetic relaxation switch to show the generality of this detection modality.

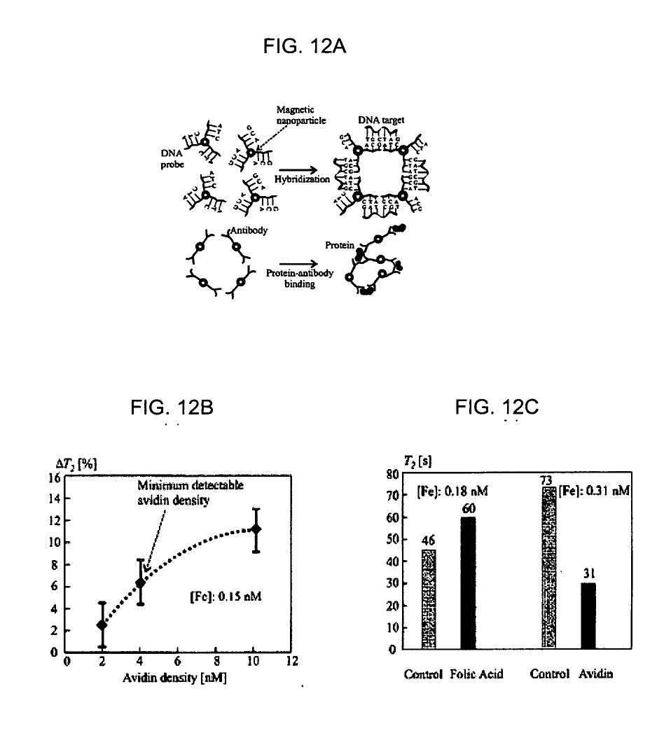

If magnetic particles, whose surfaces are modified with specific DNA strands, were introduced into a bio-sample, and target complementary strands exist in the sample, hybridizations can occur in which the magnetic particles self-assemble into clusters, as shown in FIG. 12A (top). Similarly, magnetic particles coated with antibodies can specifically bind to target proteins and self-assemble into clusters, as shown in FIG. 12A (bottom). This self-assembly of magnetic particles is based on the binding of biochemical mates (e.g., protein-antibody binding, hybridization of complementary DNA strands, avidin-biotin binding). These clusters, which produce pronounced local magnetic fields that introduce spatial and temporal modulations on top of the static magnetic field, can be detected using NMR relaxometry. This modulation introduces more precession frequency variations on top of those caused by the basic spin-spin interactions and accelerate the rate at which the protons lose phase coherence. Therefore, the resultant reduction in T2 indicates the presence of target objects (e.g., proteins, DNA strands, and avidin). This technique is referred to as a “magnetic relaxation switch.”

Avidin (ImmunoPure Avidin #21121; Pierce Biotechnology) was dissolved in PBS at a concentration of 1 mg/ml. Samples were prepared by mixing different amounts of avidin to biotinylated CLIO (CLIO-Biotin). Three sets of samples were prepared with different iron concentrations (0.2, 0.3, and 0.5 mM Fe). Following a 15 minute incubation at room temperature, NMR experiments were performed on sample volumes of 5 μl (for miniaturized NMR measurements) and 300 μl (for tabletop relaxometer measurements). For a given Fe concentration, AT2 was reported using the T2 of the sample without avidin as a reference.

FIG. 12B illustrates how the minimum detectable amount of streptavidin was calculated. As the avidin density decreases, the T2 change with respect to the no-avidin case becomes smaller. The miniaturized NMR system is sensitive enough to resolve down to 6% of T2, from which we can infer the minimum detectable amount of avidin, found to be 20 fmol (about 5 μL, i.e., a density of about 4 nM).

As shown in FIG. 12C, additional experiments were performed using the magnetic relaxation switch of the miniaturized NMR system to detect folic acid, or vitamin B9, whose deficiency is related to a number of diseases, including cancer. The measured T2 differed by 30% between samples with and without folic acid (density: 22.7 μM). In the figure, “control” means an absence of the target biomolecules (in this case, an absence of folic acid).

### Example 7

### Detection of Bacteria with the Miniaturized NMR System

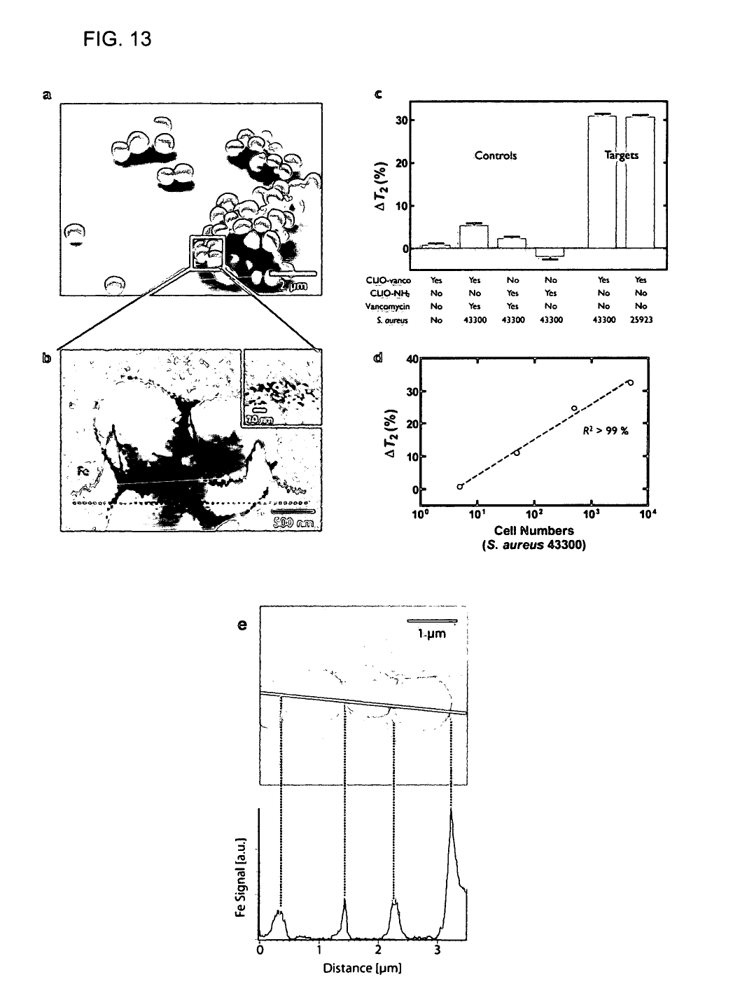

One of the compelling applications of the miniaturized NMR system is the rapid detection and characterization of infectious agents including bacteria, viruses, fungi and parasites. Developing robust and miniaturized diagnostic tools can have a high impact not only on basic biomedical and pharmaceutical research but also on global healthcare, especially in developing countries in which no or minimal laboratory structures are available. As a proof of concept, shown in FIG. 13A, we determined the sensitivity for detecting gram positive bacteria using Staphylococcus aureus (S. aureus). Magnetic particles derivatized with vancomycin served as an analyte in which the antibiotic binds to D-alanyl-D-alanine moieties in the bacterial cell wall. Following incubation with bacteria, the particles were found attached to the bacterial cell wall in dense, clustered sheets (FIGS. 13B and E). Indeed, concentration-dependent T2 decreases were observed in different S. aureus strains (FIGS. 13C-D). With its high mass sensitivity and the use of small sample volume, the miniaturized NMR system was able to detect as few as about 10 bacteria in a 10 μl sample with detection ranges spanning at least two orders of magnitude. By modifying the clustering analytes, different infectious agents could be selectively detected, e.g., mycobacterium in sputum, enterotoxic bacteria in water supplies, or respiratory pathogens in point-of-care settings.

Two strains of Staphylococcus aureus (S. aureus) were purchased (#25923 and #43300; ATCC, VA) and maintained according to the vendor's protocols. Before experiment, the bacteria were cultured in Luria-Bertani (LB) broth overnight at 37° C. The density of bacteria was estimated by measuring optical density (OD) at 600 nm. The targeting of the bacteria was confirmed by performing elemental analysis by energy dispersive X-ray spectrometry (EDS), as shown in FIGS. 13B and E.

For the proximity assay, a sample was prepared for each of the compositions listed in Table 2. All samples were incubated for 15 minutes at room temperature and T2 values were measured subsequently using 10 μl samples. The T2 value of CLIO-NH₂ with S. aureus (Control sample #3 in Table 2) was used as a reference in calculating AT2. The detection limit of the bacteria was determined by incubating the CLIO-vancomycin with S. aureus 43300 of different concentrations under the same conditions.

TABLE 2
Sample Composition for S. aureus Detection

| Composition | Control 1 | Control 2 | | Control 3 | | Control 4 | | Target 1 | | Target 2 | |
|---|---|---|---|---|---|---|---|---|---|---|---|
| CLIO- | 8.0 μg/mL | 8.0 | μg/mL | — | | — | | 8.0 | μg/mL | 8.0 | μg/mL |
| vancomycin | | | | | | | | | | | |
| CLIO-NH₂ | — | — | | 8.0 | μg/mL | 8.0 | μg/mL | — | | — | |
| Vancomycin | — | 0.1 | mM | 0.1 | mM | — | | — | | — | |
| S. aureus # | — | 1 · 10³ | CFU/mL | 1 · 10³ | CFU/mL | 1 · 10³ | CFU/mL | 1 · 10³ | CFU/mL | 1 · 10³ | CFU/mL |
| 43300 | | | | | | | | | | | |

### Example 8

### Profiling of a Mammalian Cell

Another important application of the miniaturized NMR system is profiling mammalian cells and detecting in parallel disease biomarkers in native biological samples. Detecting multiple biomarkers and circulating cells in human body fluids is an especially important task for diagnosis and prognosis of complex diseases, such as metabolic disorders and cancer. To evaluate the efficacy of the miniaturized NMR system, measurements were performed to determine i) whether mammalian cells could be detected in serum, ii) whether tumor cells could be profiled by linking binding moieties to their surface receptors, and iii) whether it would be feasible to perform multiplexed measurements on the sera of diabetic and cancer patients.

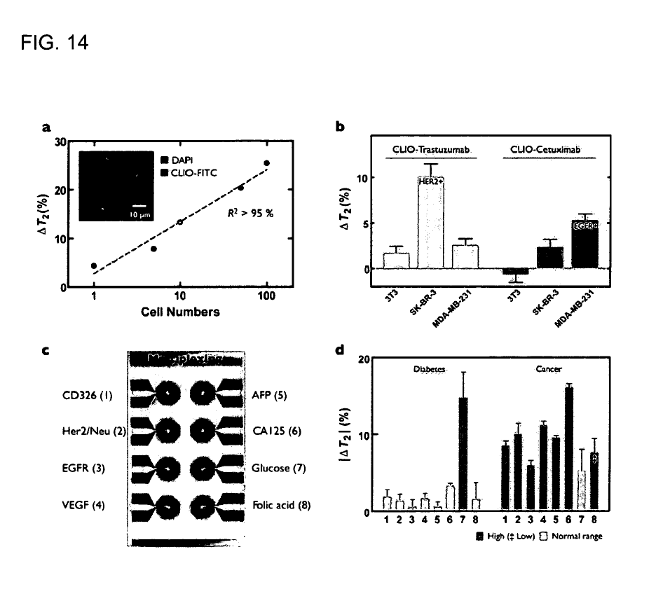

We first explored the detection limit of mammalian cells using mouse macrophages as a target. Cells were incubated with magnetic particles resulting in efficient endocytosis (FIG. 14A, inset). As shown in the plot in FIG. 14A, as cell numbers increased in the serum, more prominent T2 changes were observed. Most importantly, single cells could be detected (p<0.0001), suggesting the potential application of a miniaturized NMR system identification of circulating tumor cells, stem cells, or immune cells in blood.

Next, we attempted to profile cancer cells by targeting epidermal growth factor receptors, EGFR and Her2/Neu. Magnetic particles were functionalized with corresponding monoclonal antibodies (cetuximab for EGFR, trastuzumab for Her2/Neu) and incubated with breast cancer cells (positive control) or fibroblasts (negative control). T2 measurements were performed on 10 μl sample volumes containing about 104 cells. FIG. 14B demonstrates a selective detection of cell markers (Her2/Neu in SK-BR-3 and EGFR in MDA-MB-231). Compared to the single cell detection experiment (FIG. 14A), larger numbers of cells were used for phenotyping to create statistics, as the number of particles bound was lower. We anticipate to further increase the sensitivity of detection by using alternative magnetic particles of different sizes, compositions, and R2 relaxivity.

Mouse macrophages (RAW 264.7; ATCC, VA) were cultured in Dulbecco's Modified Eagle's Medium (DMEM). Magnetic particles functionalized with fluorescein (CLIO-FITC) were added to the culture (1 mg/ml Fe) and incubated for 3 hours at 37° C. After triple washing with Dulbecco's Phosphate-Buffered Saline (DPBS), the cells were trypsinized and suspended in DPBS containing Ca²⁺ (1 mM) and Mg²⁺ (1 mM), and cell numbers were counted using a hemacytometer.

Samples of different cell concentrations (5×102, 2.5×103, 5×103, 2.5×104, and 5×104 cell/ml) were then prepared via dilution with DPBS. Control samples were prepared under the same conditions but without incubation with CLIO-FITC. Samples for T2 measurement were prepared by adding 100 μl of cell suspension to 400 μl of DPBS, and T2 was measured on a 10 μl sample volume in quintuplicate. The change of T2 (AT2) at each cell concentration was reported using the T2 of the control sample, which had the same cell concentration but no incubation with CLIO-FITC, as a reference.

Inversion-recovery and CPMG pulse sequences were used for T1 and T2 measurements, respectively. Excitation of the samples and detection of NMR signals from the samples were performed using a prototype microcoil array for eight multiplexed measurements, as shown in FIG. 14C and described in more detail in Example 9. Detection targets are labeled in FIG. 14C. Parameters for T1 and T2 measurements are summarized in Table 3.

TABLE 3
List of Parameters for T1 and T2 Measurements

| Parameter | T1 measurement | T2 measurement |
|---|---|---|
| Pulse sequence | Inversion recovery; | Carr Purcell |
| | pulse separation: | Meiboom Gill; |
| | 5-1000 ms | echo time: 4 ms |
| Pulse width, 90o | 40 | 40 |
| Pulse width, 180o | 80 | 80 |
| Data points/scan | 26 | 36 |
| Number of scans | 16 | 64 |
| Repetition time | 2000 ms | 1000 ms |

Unless specified otherwise, all NMR experiments were carried out in triplicate at room temperature and data were displayed as mean±standard error. Results for experiments described below are summarized in FIG. 14D and in Table 4.

a) EGFR and Her2/Neu Detection

SKBR3, MDA-MB-231 and 3T3 cells in serum containing DMEM were incubated with magnetic particles functionalized with monoclonal antibodies (i.e., CLIO-Cetuximab for EGFR and CLIO-Trastuzumab for Her2/Neu) for 60 minutes at 37° C. with [Fe]=0.25 mg/ml. Control samples were prepared by incubating the cells with unmodified magnetic particles (CLIO-NH₂) under the same conditions. T2 was measured on a 10 μl sample volume in triplicate. The change of T2 for each cell type was reported using the T2 of the control sample (the same cell type incubated with CLIO-NH₂) as a reference (see FIG. 14B).

b) CD326 Detection

Magnetic particles, with [Fe]=0.25 mg/ml, functionalized with monoclonal antibodies were added to SKBR3 and 3T3 cell cultures in serum that contains DMEM and incubated for 30 minutes. Control samples were prepared by incubating the cells with unmodified magnetic particles (CLIO-NH₂). Measurements then were performed in triplicate on samples having a volume of 10 μL.

c) VEGF Detection

Human vascular endothelial growth factor (VEGF) protein was purchased (#ab9571; Abcam, MA) and diluted in PBS at a pH of 7.4. Different amounts of VEGF were added to magnetic particles functionalized with monoclonal antibodies (CLIO-Avastin) with a final [Fe]=20 μg/mL. After incubating for 30 minutes at room temperature, T2 was measured on a 5 μl sample volume.

d) AFP Detection

Human α-fetoprotein (AFP) was purchased (#F4100-19; US Biological, MA) and diluted in PBS at a pH of 7.4. Different amounts of AFP were added to magnetic particles functionalized with monoclonal antibodies (CLIO-AFPmAb) with [Fe]=10 μg/mL. Following a 30 minute incubation at room temperature, T2 was measured on a 5 μl sample volume.

e) CA125 Detection

Human cancer antigen 125 (CA125) was purchased (#C0050; US Biological) and diluted in PBS at a pH of 7.4. Samples were prepared in the same fashion described above using magnetic particles functionalized with monoclonal antibodies (CLIO-CA 125 mAb), and the same method was applied for T2 measurement.

f) Glucose Detection

For glucose detection, a continuous analyte sensing method based on an equilibrium between analytes and binding proteins was applied. Specifically, Concanavalin-A (Con-A) was added to the suspension of magnetic particles conjugated with glucose ([Fe]=15 μg/ml). Con-A was first added as a binding protein with a final concentration, [Con-A], of 1 mg/ml. The suspension contained Mg²⁺ (1 mM) and Ca²⁺ (1 mM) to initiate binding between Con-A and glucose. After a 15-minute incubation at room temperature, the T2 decreased from an initial value of 74 msec to a steady value of 28 msec. Subsequently, different amounts of glucose were added and incubated for 15 minutes each at room temperature, leading to a dose-dependent T2 increase. T2 was measured on a 5 μl sample volume.

g) FA Detection

Folic acid (FA) detection was performed in a similar manner as in glucose detection. FA was added to the suspension of magnetic particles conjugated with FA ([Fe]=10 μg/ml) polyclonal antibodies (#ab37013; Abcam) to initiate an aggregation of particles. The final dilution factor of the antibodies in samples was 400. After a 15-minute incubation at room temperature, the T2 dropped from 130 msec to 109 msec. Different doses of FA were mixed with the aggregated samples and incubated for 15 minutes at room temperature. All T2 measurements were performed on a 5 μl sample volume.

TABLE 4
Sample Composition and Diagnostic Criteria
for Multiplexed Detection

| | Normal | Diabetic | Cancer | Normal |
|---|---|---|---|---|
| Sensing target | serum | serum | serum | range |
| CD326 (cell/μL); | 0 | 0 | 1000 | 0 |
| SK-BR-3 | | | | |
| CD326 (cell/μL); 3T3 | 1000 | 1000 | 0 | — |
| Her2/Neu (cell/μL); | 0 | 0 | 1000 | 0 |
| SK-BR-3 | | | | |
| Her2/Neu (cell/μL); | 1000 | 1000 | 0 | — |
| 3T3 | | | | |
| EGFR (cell/μL); | 0 | 0 | 1000 | 0 |
| MDA-MB-231 | | | | |
| EFGR (cell/μL); 3T3 | 1000 | 1000 | 0 | — |
| VEGF (ng/mL) | <0.1 | <0.1 | 5 | <0.5 |
| AFP (ng/mL) | <50 | <50 | 300 | <10 |
| CA125 (U/mL) | <10 | <10 | 500 | <35 |
| Glucose (mg/dL) | 70 | 126 | 70 | <70 |
| Folic acid (ng/mL) | 2.7 | 5 | 1 | 2.7-12.7 |

### Example 9

### Multiplexed Measurements

One of the advantages of the miniaturized NMR system is its capability to sense different types of markers (e.g., DNA, protein, metabolites) by multiplexing arrays of microcoils. In one example, we created a 2×4 microcoil array, shown in FIG. 14C, and used differently-targeted particles conjugated with matching antibodies or proteins to profile serum samples.

Such samples, representing healthy, diabetic and cancer patients, were obtained by spiking relevant markers into normal serum. The measurement results, shown in FIG. 14D, illustrate how different patient conditions can be identified from single parent samples.

Our results show that the described miniaturized NMR system represents a highly-sensitive, reproducible platform for target detection. The miniaturized NMR system can perform parallel detection of biomolecules along specific cellular pathways or can detect small molecule-protein interaction, metabolites, stem cells and chemical steroisomers. Table 4 summarizes the sera compositions and the diagnostic criteria for multiplexed detection, illustrated in FIG. 14C. Relative changes of T2 (|ΔT2|) for each sensing target are reported in FIG. 14D, using the T2 measured for the healthy serum as a reference. All markers, except folic acid, showed a decrease in T2 for the abnormal conditions of diabetes or cancer; T2 was found to be higher in abnormal conditions for folic acid. ΔT2 was computed using mean values and standard errors from measurements in triplicate.

### Other Embodiments

It is to be understood that while the invention has been described, the foregoing description is intended to illustrate and not to limit the scope of the invention, which is defined by the scope of the appended claims. Other aspects, advantages, and modifications are within the scope of the following claims.

1. A miniaturized magnetic resonance system comprising:
a permanent magnet;
at least one microcoil;
a microfluidic network comprising at least one cylindrical chamber and one or more three-dimensional channel networks; and
a monolithic integrated circuit configured to transmit an excitation signal to a microcoil and to receive an input signal from a microcoil, and comprising a pulse generator and a low noise amplifier.

2. The system of claim 1, wherein the pulse generator comprises a digital pulse generator.

3. The system of claim 1, wherein the dimensions of the system are less than about 30 centimeters by about 40 millimeters by about 2 centimeters.

4. The system of claim 1, wherein the circuit comprises a heterodyne transceiver.

5. The system of claim 1, wherein at least one amplifier comprises a cascode structure.

6. The system of claim 1, further comprising a variable gain amplifier.

7. The system of claim 1, wherein at least one amplifier comprises a fully-differentiable amplifier.

8. The system of claim 1, further comprising a voltage-controlled oscillator.

9-11. (canceled)

12. The system of claim 1, wherein the at least one microcoil is fabricated on a substrate.

13. (canceled)

14. The system of claim 1, wherein the microfluidic network further comprises heating elements with temperature sensors.

15-17. (canceled)

18. The system of claim 1, wherein the one or more three-dimensional channel networks mix a first input fluid and a second input fluid using chaotic advection.

19. The system of claim 18, wherein the first input fluid comprises target molecules and the second input fluid comprises conjugates that specifically bind to the target molecules.

20. The system of claim 1, wherein the microfluidic network is patterned in a resin substrate.

21. The system of claim 1, wherein the microfluidic network is attached to the circuit.

22. A method for detecting a target molecule in less than 10 microliters of a fluid sample, the method comprising:
obtaining conjugates that specifically bind to the target molecule, wherein each conjugate comprises a nanoparticle comprising a magnetic metal oxide linked to a moiety that binds to the target molecule:
contacting the conjugates with the fluid sample under conditions that enable the conjugates to bind specifically to any target molecules in the sample and form an aggregate of conjugates;
obtaining at least two measurements of a relaxation property of the sample using a miniaturized nuclear magnetic resonance system of claim 1, wherein the measurements are performed before and after at least one addition of the conjugates; and
detecting an aggregate in the sample, wherein a presence of the aggregate indicates a presence of the target molecule.

23. The method of claim 22, wherein a dynamic range of detection comprises four orders of magnitude of target molecule concentration.

24. The method of claim 22, wherein the method detects a concentration of at least 1 nanogram of the target molecule.

25-28. (canceled)

29. The method of claim 22, wherein the target molecule comprises a surface marker of a cell.

30-32. (canceled)

33. The method of claim 29, wherein the method can detect at least one cell.

34-35. (canceled)

36. An assay method for detecting a target molecule in less than 10 microliters of a fluid sample, the method comprising:
adding conjugates to less than 10 microliters of fluid sample, wherein each conjugate comprises a nanoparticle comprising a magnetic metal oxide linked to a moiety that binds to the target molecule;
obtaining at least two measurements of a relaxation property of the less than 10 microliters of sample, using the miniaturized nuclear magnetic resonance system of claim 1, wherein the measurements are performed before and after at least one addition of the conjugates; and
detecting an aggregate in the less than 10 microliters of sample, wherein the presence of the aggregate indicates the presence of the target molecule.

37-42. (canceled)
